(19) United States
(12) Patent Application Publication
(10) Pub. No.: US 2010/0267871 A1
(43) Pub. Date: Oct. 21, 2010

(54) ORGANOPHOSPHONATE OLIGOMERS

(75) Inventors: Techen Tsao, Baton Rouge, LA (US); Arthur G. Mack, Prairieville, LA (US); William J. Layman, Baton Rouge, LA (US); Jeffrey Todd Aplin, Pasadena, TX (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 12/681,885

(22) PCT Filed: Oct. 16, 2008
(86) PCT No.: PCT/US08/80101

§ 371 Date: Apr. 6, 2010

Related U.S. Application Data
(60) Provisional application No. 60/983,794, filed on Oct. 30, 2007.

(51) Int. Cl. C08K 5/52; C07F 9/06

(52) U.S. Cl. 524/127; 558/163

(57) ABSTRACT

This invention provides chlorohydrocarbyloxy phosphonate oligomers, organophosphonate oligomers, and processes for the preparation of such oligomers. The chlorohydrocarbyloxy phosphonate oligomers can be represented by the formula (IV) where R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring; R² is an alkyl group or an aromatic group; and n is a number from about 2 to about 20.

### TECHNICAL FIELD

This invention relates to the preparation, provision, and use of organophosphonate oligomers.

### BACKGROUND

Effective phosphorus-containing flame retardants, both halogenated and non-halogenated, are known in the industry. However, there is still a need for phosphorus flame retardants which are non-fugitive, have a high phosphorus content, and are compatible with polymers, especially polyurethane, for thermoprocessing.

### SUMMARY OF THE INVENTION

This invention provides organophosphonate oligomers having a high phosphorus content that can be used as flame retardants, and processes for making such organophosphonate oligomers.

An embodiment of this invention is a chlorohydrocarbyloxy phosphonate oligomer represented by the formula

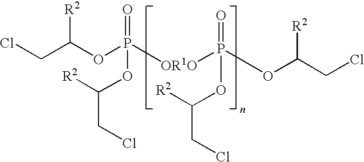

where
R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring;
R² is an alkyl group or an aromatic group; and
n is a number from about 2 to about 20.

Another embodiment of this invention is an organophosphonate oligomer represented by the formula

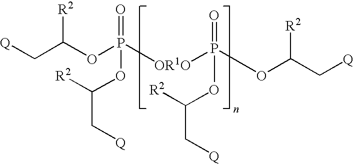

where
R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring;
R² is an alkyl group or an aromatic group:
n is a number from about 2 to about 20; and
Q is represented by the formulae

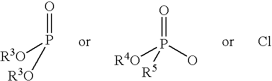

where R³, R⁴, and R⁵ are each, independently, an alkyl group, with the proviso that no more than about 50 mole percent of Q in each organophosphonate oligomer is comprised of chlorine atoms.

Still another embodiment of this invention is a process for producing an organophosphonate oligomer, which process comprises three steps. The first step, step I), comprises bringing together phosphoric trichloride and at least one diol, to thereby form a first reaction mixture and form a chlorophosphonate oligomer product. In this step, the moles of phosphoric trichloride and the moles of diol are in a ratio of about x+y:x, where x is in the range of about 3 to about 6 and y is a value from a fractional number less than 1 to about 2.

The second step of the process, step II), comprises bringing together at least a portion of the chlorophosphonate oligomer product from step I) and at least one 1,2-epoxide, and optionally a catalyst, to thereby form a second reaction mixture and form a chlorohydrocarbyloxy phosphonate oligomer product.

Step III), the third step of the process, comprises bringing together at least a portion of the chlorohydrocarbyloxy phosphonate oligomer product from step II) and either a) at least one trialkyl phosphite, to thereby form a third reaction mixture, and heating said third reaction mixture, or b) at least one methyl alkyl alkanephosphonate and a catalyst, to thereby form a third reaction mixture. An organophosphonate oligomer product is formed.

These and other features of this invention will be still further apparent from the ensuing description, drawings, and appended claims.

### BRIEF DESCRIPTION OF THE DRAWINGS

FIG. 1 shows the overall reactions for steps I) and II) of the processes of the invention.

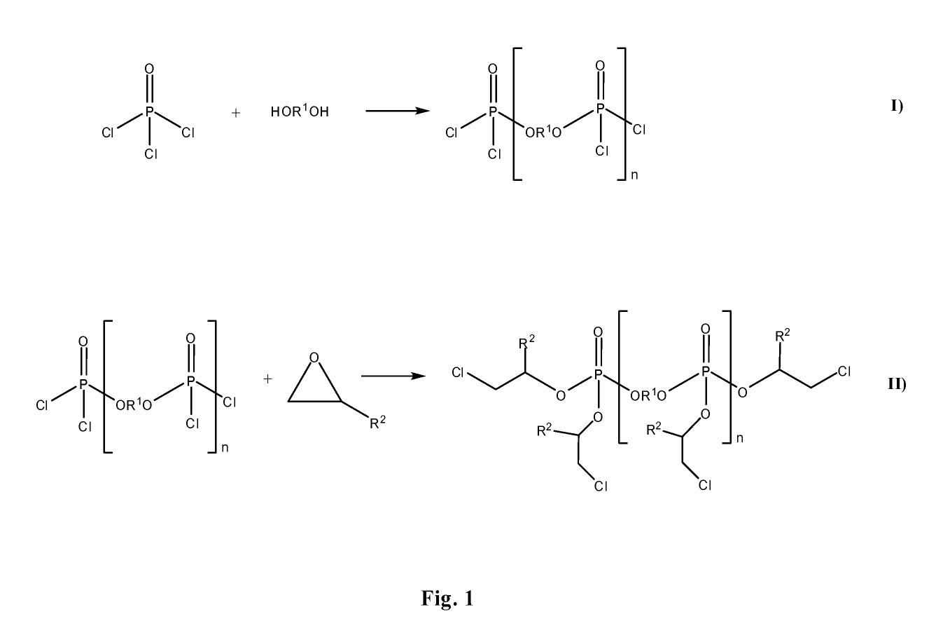

FIG. 2 shows an overall reaction for step III) of the processes of the invention.

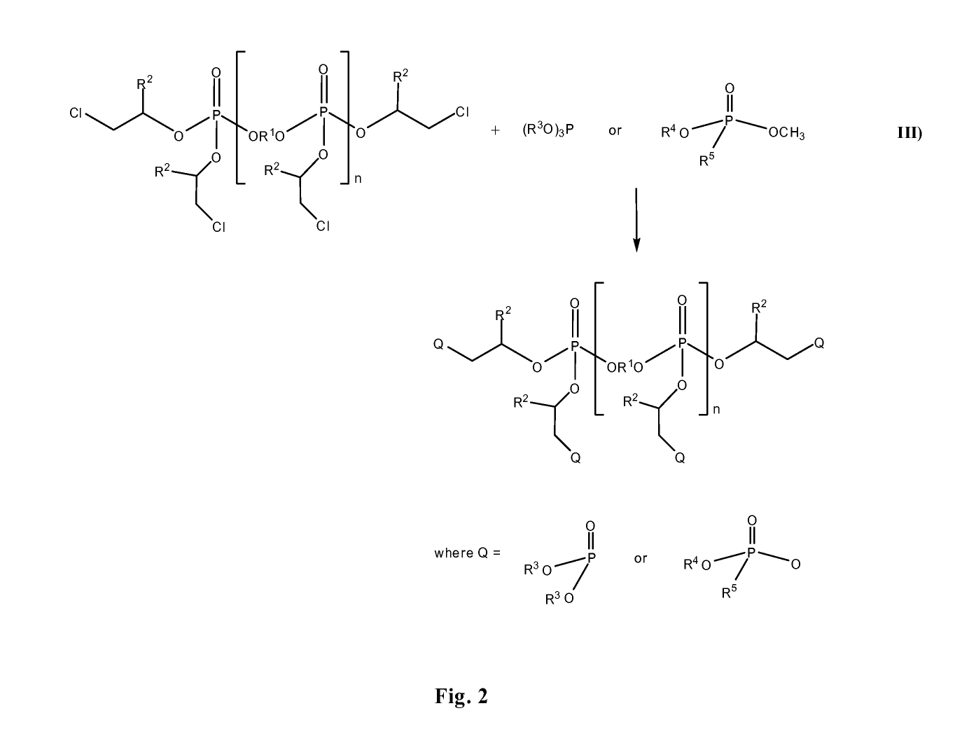

### FURTHER DETAILED DESCRIPTION OF THE INVENTION

Throughout this document, the terms “oligomeric organophosphonate” and “organophosphonate oligomer” are used interchangeably. The term “oligomeric chlorohydrocarbyloxy phosphonate” is used interchangeably with “chlorohydrocarbyloxy phosphonate oligomer” throughout this document. Throughout this document, the terms “ring-containing diol” and “diol having at least one cycloaliphatic or aromatic ring in the molecule” are used interchangeably.

The structural formulae shown throughout this document are not intended to depict any particular stereoisomeric configuration for the structures shown. Consequently, the formulae shown do not constitute any representation, let alone limitation, concerning the geometric configuration of the structures shown.

As described above, the chlorohydrocarbyloxy phosphonate oligomers of this invention are represented by the formula

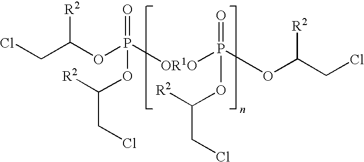

where
R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring;
R² is an alkyl group or an aromatic group; and n is a number from about 2 to about 20.
When R¹ is a linear or branched hydrocarbylene group or oxygen-containing hydrocarbylene group having about two to about twenty carbon atoms, preferably about two to about ten carbon atoms; linear aliphatic hydrocarbylene groups are preferred. Suitable hydrocarbylene groups R¹ include ethylene, 3-oxa-1,5-pentylene, 1,2-propylene, 1,3-propylene, 1,2-butylene, 2,3-butylene, 1,4-butylene, 2,3-dimethyl-2,3-butylene, 1,5-pentylene, 3,6,9,12-tetraoxa-1,14-tetradecylene, 4-oxa-1,7-heptylene, 1,6-hexylene, 2,5-hexylene, 1,7-heptylene, 1,8-octylene, 1,9-nonylene, 1,10-decylene, and the like. 3-Oxa-1,5-pentylene and 4-oxa-1,7-heptylene are preferred linear hydrocarbylene groups.

When R¹ has at least one cycloaliphatic or aromatic ring, one or both of the oxygen atoms shown in the above formula can be attached to the ring. Ring-containing R¹ has about five to about thirty carbon atoms; preferably, ring-containing R¹ has about eight to about twenty carbon atoms. There can be one or more hydrocarbyl substituents on the ring(s) of R¹. Suitable ring-containing groups R¹ having at least one cycloaliphatic ring include, but are not limited to, 1,3-cyclopentylene, 1,2-cyclohexylene, 1,3-cyclohexylene, 1,4-cyclohexylene, 4,6-dimethyl-1,3-cyclohexylene, 1,2-cyclohexanedimethylene, 1,3-cyclohexanedimethylene, 1,4-cyclohexanedimethylene, 1-ethyl-1,4-cyclohexane-dimethylene, 2-cyclohexyl-1,3-propylene, 1,4-cyclooctylene, 1,5-cyclooctylene, and 4,4′-(1,1′-bicyclohexylene). Suitable ring-containing groups R¹ having at least one aromatic ring include, but are not limited to, 1,2-phenylene, 4-methyl-1,2-phenylene, 1,3-phenylene, 2-methyl-1,3-phenylene, 4-methyl-1,3-phenylene, 1,4-phenylene, 2-methyl-1,4-phenylene, 2-tert-butyl-1,4-phenylene, 2,3-dimethyl-1,4-phenylene, trimethyl-1,4-phenylene, 4-(methylene)phenyl, 1,2-benzenedimethylene, 1,3-benzenedimethylene, 1,4-benzenedimethylene, 1,2-naphthylene, 1,3-naphthylene, 1,4-naphthylene, 1,5-naphthylene, 1,6-naphthylene, 1,7-naphthylene, 2,3-naphthylene, 2,6-naphthylene, 2,7-naphthylene, 3,6-naphthylene, 1,8-naphthalenedimethylene, and the like.

When R² is an alkyl group, it preferably has one to about fifteen carbon atoms and when R² is an aromatic group, it preferably has about six to about twenty carbon atoms. More preferably, R² has one to about eight carbon atoms when it is an alkyl group, and about six to about twelve carbon atoms when it is an aromatic group. Suitable groups R² include methyl, ethyl, propyl, butyl, pentyl, hexyl, isopropyl, isobutyl, tert-butyl, phenyl, 2-methylphenyl, 3-methylphenyl, 4-methylphenyl, 4-butylphenyl, 3,5-dimethylphenyl, (1,1′-biphenyl-)-4-yl, naphthyl, benzyl, 4-methylbenzyl, 4-ethylbenzyl, 2-phenylethyl, 3-methylphenethyl, and the like.

The value of n is preferably in the range of about 5 to about 10.

Phosphoric trichloride, one of the reagents used in the first step of the processes of this invention, is also commonly referred to in the art by other names, including phosphorus oxychloride and phosphoryl chloride.

In the processes of this invention, the diol is usually a linear or branched aliphatic diol or a diol having at least one cycloaliphatic or aromatic ring in the molecule.

The linear or branched aliphatic diols used in the processes of this invention generally have about two to about twenty carbon atoms, and preferably have two to about ten carbon atoms. Linear diols are preferred. More preferred linear or branched diols are oxygen-containing diols, and alpha-omega alkane diols having about six to about twelve carbon atoms in the molecule.

Examples of linear or branched diols that can be used in the practice of this invention include ethylene glycol, diethylene glycol, 1,2-propanediol (propylene glycol), 1,3-propanediol, 1,2-butanediol, 2,3-butanediol, 1,4-butanediol, pinacol (2,3-dimethyl-2,3-butanediol), 1,5-pentanediol, pentaethylene glycol, dipropylene glycol, 1,6-hexanediol, 2,5-hexanediol, 1,7-heptanediol, 1,8-octanediol, 1,9-nonanediol, 1,10-decanediol, and the like. Diethylene glycol and dipropylene glycol are preferred diols in the practice of this invention.

When the diol has at least one cycloaliphatic or aromatic ring in the molecule, one or both of the hydroxy groups can be attached to the ring. The ring-containing diol usually has about five to about thirty carbon atoms; preferably, the ring-containing diol has about eight to about twenty carbon atoms. There can be one or more hydrocarbyl substituents on the ring(s) of the ring-containing diol. Mixtures of two or more diols having at least one cycloaliphatic or aromatic ring in the molecule can be used in the practice of this invention.

Suitable diols having at least one cycloaliphatic ring in the molecule include, but are not limited to, 1,3-cyclopentanediol, cyclohexane-1,2-diol, cyclohexane-1,3-diol, cyclohexane-1,4-diol, 4,6-dimethyl-cyclohexane-1,3-diol, 1,2-cyclohexanedimethanol, 1,3-cyclohexanedimethanol, 1,4-cyclohexanedimethanol, 1-ethyl-1,4-cyclohexanedimethanol, 2-cyclohexyl-1,3-propanediol, cyclooctane-1,4-diol, cyclooctane-1,5-diol, (1,1′-bicyclohexyl)-4,4′-diol, and the like.

Suitable diols having at least one aromatic ring in the molecule include, but are not limited to, catechol, 4-methylcatechol, resorcinol, 2-methylresorcinol, 4-methylresorcinol, hydroquinone, 2-methylhydroquinone, 2-tert-butylhydroquinone, 2,3-dimethylhydroquinone, trimethylhydroquinone, 4-(hydroxymethyl)phenol, 1,2-benzenedimethanol, 1,3-benzenedimethanol, 1,4-benzenedimethanol, 1,2-dihydroxynaphthalene, 1,3-dihydroxynaphthalene, 1,4-dihydroxynaphthalene, 1,5-dihydroxynaphthalene, 1,6-dihydroxynaphthalene, 1,7-dihydroxynaphthalene, 2,3-dihydroxynaphthalene, 2,6-dihydroxynaphthalene, 2,7-dihydroxynaphthalene, 3,6-dihydroxynaphthalene, 1,8-naphthalenedimethanol, and the like.

In the processes of this invention, a mixture of two or more diols can be used, including mixtures of two or more linear and/or branched diols, mixtures of two or more ring-containing diols, and mixtures of at least one linear or branched diol and at least one ring-containing diol.

The moles of phosphoric trichloride and the moles of diol are in a ratio of about x+y:x, where x is in the range of about 3 to about 6 and y is a value from a fractional number less than 1 to about 2. In the ratio of x+y:x, the molar amount of phosphoric trichloride is always in excess of the total moles of diol. Preferred values for y are in the range of about 0.75 to about 1.75; y is more preferably about 1.

A chlorophosphonate oligomer is formed in the first step of the processes of this invention, in which phosphoric trichloride and at least one diol are brought together. The order of combination can be any which is convenient to the operator. The reaction in this step is usually exothermic, so cooling of the reaction mixture is recommended and preferred.

When the diol has an aromatic ring, once the components have been brought together, the reaction mixture so formed (the first reaction mixture) is heated, normally and preferably to a temperature in the range of about 70° C. to about 120° C., more preferably to a temperature in the range of about 80° C. to about 100° C. In a preferred way of conducting the process, the reaction is driven as far as possible toward completion by continuing to heat the first reaction mixture while gradually decreasing the pressure (e.g., decreasing the pressure from about atmospheric to about several ton over about three hours).

For first-step processes in which the diol is a linear or branched diol, or a diol having at least one cycloaliphatic ring in the molecule, heating is often unnecessary, at least at the beginning of the reaction. In some instances, heating may be desirable, either from the beginning of the process or from a point after the beginning of the process. When the first reaction mixture is heated, the temperature is usually in the range of about 20° C. to about 50° C., more preferably in the range of about 20° C. to about 40° C. When heat is applied to the first reaction mixture in which the diol is a linear or branched diol, or a diol having at least one cycloaliphatic ring in the molecule, toward end of reaction the heat may be increased as necessary, to drive the reaction as far as possible toward completion by continuing to heat the first reaction mixture.

After the reaction, volatile organic components can be removed by distillation. A preferred method for removing volatile organic components is by heating the reaction mixture while gradually decreasing the pressure (e.g., decreasing the pressure from about atmospheric to about several ton over about three hours). Alternatively, chlorophosphonate oligomer produced in this first step can be used in the second step of the process without purification.

Herein, the term 1,2-epoxide signifies that the epoxide ring involves the carbon atoms in the 1- and 2-positions. In the formula

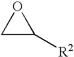

R² is an alkyl group, an aromatic group, or an aralkyl group. When R² is an alkyl group, it preferably has one to about fifteen carbon atoms; when R² is an aromatic group, it preferably has about six to about twenty carbon atoms; and when R² is an aralkyl group, it preferably has about seven to about twenty-five carbon atoms. More preferably, R² has one to about eight carbon atoms when it is an alkyl group, about six to about twelve carbon atoms when it is an aromatic group, and about seven to about twelve carbon atoms when it is an aralkyl group.

Suitable 1,2-epoxides include, but are not limited to, propylene oxide, 1-butene oxide, 1-pentene oxide, 1-hexene oxide, 1-heptene oxide, 1-octene oxide, 2-isopropyl oxirane, isobutyl oxirane, tert-butyl oxirane, phenyl oxirane, 2-methylphenyl oxirane, 3-methylphenyl oxirane, 4-methylphenyl oxirane, 4-butylphenyl oxirane, 3,5-dimethylphenyl oxirane, (1,1′-biphenyl-)-4-yl oxirane, 2-naphthyloxirane, 2-benzyloxirane, 2-(4-methylbenzyl)oxirane, 2-(4-ethylbenzyl)oxirane, 2-phenylethyloxirane, 2-(3-methylphenethyl)oxirane, and the like.

In the second step of the processes of this invention, in which a chlorohydrocarbyloxy organophosphonate oligomer product is formed, at least one 1,2-epoxide and a chlorophosphonate oligomer are brought together to thereby form a second reaction mixture. All or a portion of the chlorophosphonate oligomer formed in the first step of the process can be used in this second step. The order of combination can be any which is convenient to the operator, although it generally preferable to add the epoxide to the chlorophosphonate oligomer. The reaction in this step is usually exothermic, so cooling of the reaction mixture is recommended and preferred.

The reaction in this step can be slow; thus, the inclusion of a catalyst is usually recommended and preferred. Typically, the catalyst is a titanium tetraalkoxide. Examples of such catalysts include titanium methoxide, titanium ethoxide, titanium propoxide, titanium isopropoxide, titanium butoxide, and the like. Typically, the alkoxide groups of the titanium tetraalkoxide contain one to about eight carbon atoms, although there can be more than eight carbon atoms in the alkoxide groups without departing from the scope of the invention.

Once the components have been brought together, the reaction mixture so formed (the second reaction mixture) is usually heated, normally to a temperature of at least about 70° C., preferably to a temperature in the range of about 70° C. to about 120° C., and more preferably to a temperature in the range of about 80° C. to about 100° C. In a preferred way of conducting the process, the reaction is driven as far as possible toward completion by continuing to heat the second reaction mixture.

After the reaction, volatile organic components can be removed by distillation. A preferred method for removing volatile organic components is by heating the reaction mixture while gradually decreasing the pressure (e.g., decreasing the pressure from about atmospheric to about several ton over about three hours). Alternatively, chlorohydrocarbyloxy organophosphonate oligomer produced in this second step can be used in the third step of the process without purification. Some of the chlorohydrocarbyloxy organophosphonate oligomers produced may have the R² group at the β-position of the chlorohydrocarbyloxy group (on the carbon atom adjacent to the chlorine atom); such products are within the scope of this invention.

As described above, the organophosphonate oligomers of this invention are represented by the formula

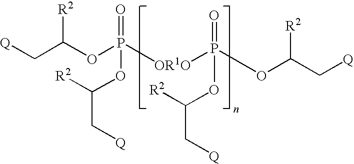

where
R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring;
R² is an alkyl group or an aromatic group:
n is a number from about 2 to about 20; and
Q is represented by the formulae

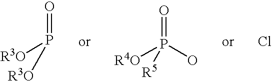

where R³, R⁴, and R⁵ are each, independently, an alkyl group, with the proviso that no more than about 50 mole percent of Q in each organophosphonate oligomer is comprised of chlorine atoms. Preferably, no more than about 10 mole percent of Q in each organophosphonate oligomer is comprised of chlorine atoms.

In the formulae for the organophosphonate oligomers of this invention, the preferences for R¹, R², and n are as described above for the chlorohydrocarbyloxy phosphonate oligomers of the invention.

In the third step of the processes of this invention, fewer than all of the chlorine atoms may be replaced by phosphito or phosphonato groups. Thus, chlorine can be present in these molecules, possibly in significant amounts, especially for larger values of n.

When Q is

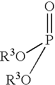

the organophosphonate oligomer can be represented by the structure below.

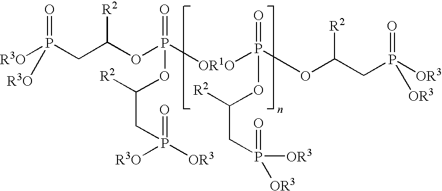

The alkyl groups R³ of the organophosphonate oligomer typically have one to about eight carbon atoms; the alkyl groups R³ may be the same or different. Examples of suitable alkyl groups for R³ include, but are not limited to, methyl, ethyl, propyl, isopropyl, butyl, isobutyl, pentyl, cyclopentyl, hexyl, cyclohexyl, and isooctyl.

When Q is

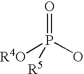

the organophosphonate oligomer can be represented by the structure below.

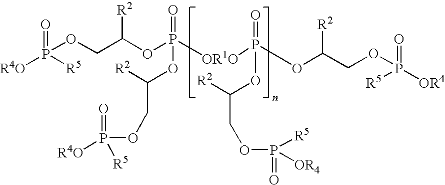

The alkyl groups R⁴ and R⁵ of the organophosphonate oligomer typically have one to about eight carbon atoms; the alkyl groups R⁴ and R⁵ may be the same or different. Examples of suitable alkyl groups for R⁴ and R⁵ include, but are not limited to, methyl, ethyl, propyl, isopropyl, butyl, isobutyl, pentyl, cyclopentyl, hexyl, cyclohexyl, and octyl.

It is to be understood that the above two organophosphonate oligomer formulae are representative, as a portion of the sites Q may be chlorine atoms. In other words, less than all of the sites Q in the in the above two organophosphonate oligomer formulae may be phosphorus groups.

Trialkyl phosphites can be used in the third step of the processes of this invention. The alkyl groups R³ of the trialkyl phosphite typically have one to about eight carbon atoms; the alkyl groups in a particular trialkyl phosphite may be the same or different. Examples of trialkyl phosphites that can be used in the practice of this invention include, but are not limited to, trimethyl phosphite, triethyl phosphite, dimethyl ethyl phosphite, tripropyl phosphite, tri(isopropyl) phosphite, tributyl phosphite, tri(isooctyl) phosphite, tripentyl phosphite, and trihexyl phosphite, methyl dipropyl phosphite, dimethyl cyclopentyl phosphite, and diethyl cyclohexyl phosphite. Mixtures of two or more trialkyl phosphites can be used.

The methyl alkyl alkanephosphonates can be represented by the formula R⁵P(O)(OR⁴)(OCH₃), where R⁴ and R⁵ are the same or different, and each is an alkyl group. In these compounds, R⁴ and R⁵ in the formula are alkyl groups. R⁵ is directly bonded to phosphorus. Although R⁵ in the formula an alkyl group, R⁵ is named as an alkane group to distinguish it from the ester-linked groups (CH₃ and R⁴). For example, when R⁵ is a methyl group, the methyl alkyl alkanephosphonate is called a methyl alkyl methanephosphonate. R⁴ and R⁵ each, independently, preferably have from one to about eight carbon atoms. Methyl alkyl alkanephosphonates that can be used in the practice of this invention include dimethyl methanephosphonate, diethyl ethanephosphonate, dimethyl ethanephosphonate, methyl ethyl ethanephosphonate, dimethyl n-butanephosphonate, methyl ethyl pentanephosphonate, hexyl ethyl methanephosphonate, cyclohexyl methyl methanephosphonate, dimethyl octanephosphonate, and the like.

An organophosphonate oligomer is formed in the third step of the processes of this invention, in which at least one trialkyl phosphite or at least one methyl alkyl alkanephosphonate and a chlorohydrocarbyloxy phosphonate oligomer are brought together to form a third reaction mixture. All or a portion of the chlorohydrocarbyloxy phosphonate oligomer formed in the second step of the process can be used in this third step.

When the reagent used with the chlorohydrocarbyloxy phosphonate oligomer is at least one trialkyl phosphite, once the components have been brought together, the reaction mixture so formed (the third reaction mixture) is heated, normally to a temperature of at least about 100° C., preferably to a temperature in the range of about 115° C. to about 180° C., and more preferably to a temperature in the range of about 120° C. to about 170° C. In a preferred way of conducting the process, the reaction is driven as far as possible toward completion by continuing to heat the third reaction mixture.

When the reagent used with the chlorohydrocarbyloxy phosphonate oligomer is at least one methyl alkyl alkanephosphonate, the presence of a catalyst is usually recommended and preferred. Typically, the catalyst is an alkali metal carbonate, an example of such a catalyst is sodium carbonate.

The amount of trialkyl phosphite or methyl alkyl alkanephosphonate used to form the organophosphonate oligomer is generally at least about 50 mole percent per mole of chlorine atoms present in the chlorohydrocarbyloxy phosphonate oligomer. Preferably, the amount of trialkyl phosphite or methyl alkyl alkanephosphonate is at least about 80 mole percent per mole of chlorine atoms present in the chlorohydrocarbyloxy phosphonate oligomer. Even when an excess of trialkyl phosphite or methyl alkyl alkanephosphonate is used, not all of the chlorine atoms of the chlorohydrocarbyloxy phosphonate oligomer may be replaced. Thus, the organophosphonate oligomers of the invention can contain chlorine.

After the reaction, volatile organic components can be removed by distillation. A preferred method for removing volatile organic components is by heating the reaction mixture while gradually decreasing the pressure (e.g., decreasing the pressure from about atmospheric to about several torr over about three hours).

The organophosphonate oligomers of this invention can be used as flame retardants in, or in connection with, polyurethane resins and composites, flexible polyurethane foams, or rigid polyurethane foams, thus forming flame-retardant polyurethane compositions. In addition, the organophosphonate oligomers of this invention can be used as flame retardants in, or in connection with, phenolic resins, paints, varnishes, and textiles.

Besides being effective as flame retardants in polyurethanes, the organophosphonate oligomers formed in the processes of this invention may be used as additive flame retardants in formulations with other flammable materials. The material may be macromolecular, for example, a cellulosic material or a polymer. Illustrative polymers are: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g. high impact polystyrene, and styrene copolymers; polyamides; polyimides; polycarbonates; polyethers; acrylic resins; polyesters, especially poly(ethyleneterephthalate) and poly(butyleneterephthalate); thermosets, for example, epoxy resins; elastomers, for example, butadiene/styrene copolymers and butadiene/acrylonitrile copolymers; terpolymers of acrylonitrile, butadiene and styrene; natural rubber; butyl rubber and polysiloxanes. The polymer may be, where appropriate, cross-linked by chemical means or by irradiation. When an organophosphonate oligomer of this invention is used with any of these polymers, a flame-retardant polymer composition is formed. The organophosphonate oligomers of this invention also can be used in textile applications, such as in latex-based back coatings.

The amount of organophosphonate oligomer of this invention used in a formulation will be that quantity needed to obtain the flame retardancy sought. It will be apparent to those skilled in the art that for all cases no single precise value for the proportion of the product in the formulation can be given, since this proportion will vary with the particular flammable material, the presence of other additives and the degree of flame retardancy sought in any give application. Further, the proportion necessary to achieve a given flame retardancy in a particular formulation will depend upon the shape of the article into which the formulation is to be made, for example, electrical insulation, tubing, electronic cabinets and film will each behave differently. In general, however, the formulation, and resultant product, may contain from about 1 to about 30 wt %, preferably from about 5 to about 25 wt % of an oligomeric product of this invention. Masterbatches of polymer containing an oligomeric flame retardant of this invention, which are blended with additional amounts of substrate polymer, typically contain even higher concentrations of the oligomer, e.g., up to 50 wt % or more.

Any of several conventional additives used in thermoplastic formulations may be used, in their respective conventional amounts, with the oligomeric flame retardants of this invention, e.g., plasticizers, antioxidants, fillers, pigments, UV stabilizers, etc.

Thermoplastic articles formed from formulations containing a thermoplastic polymer and an oligomeric product of this invention can be produced conventionally, e.g., by injection molding, extrusion molding, compression molding, and the like. Blow molding may also be appropriate in certain cases.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent, patent application and printed publication referred to above is incorporated herein by reference in tow to the fullest extent permitted as a matter of law.

This invention is susceptible to considerable variation in its practice. Therefore, the foregoing description is not intended to limit, and should not be construed as limiting, the invention to the particular exemplifications presented hereinabove.

1. (canceled)

2. An organophosphonate oligomer represented by the formula 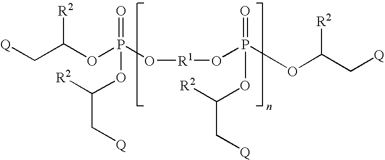
where
R¹ is a linear or branched hydrocarbylene group or oxygen-containing hydrocarbylene group, which hydrocarbylene group has about two to about twenty carbon atoms, or a hydrocarbylene group having at least one cycloaliphatic or aromatic ring;
R² is an alkyl group or an aromatic group:
n is a number from about 2 to about 20; and
Q is either 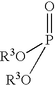
or a mixture thereof with Cl
or 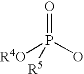
or a mixture thereof with Cl
where R³, R⁴, and R⁵ are each, independently, an alkyl group, with the proviso that no more than about 50 mole percent of Q in each organophosphonate oligomer is comprised of chlorine atoms.

3. An oligomer as in claim 2 wherein R¹ is a linear aliphatic hydrocarbylene group, or wherein R¹ is a 3-oxa-1,5-pentylene group or a 4-oxa-1,7-heptylene group.

4. (canceled)

5. An oligomer as in claim 2 wherein
R² is an alkyl group which has one to about eight carbon atoms; or
R² is an aromatic group which has about six to about twelve carbon atoms.

6. An oligomer as in claim 2 wherein Q is 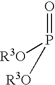
or a mixture thereof with Cl
and wherein R³ has one to about eight carbon atoms, or
wherein Q is 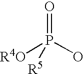
or a mixture thereof with Cl
wherein R⁴ has one to about eight carbon atoms, and wherein R⁵ has one to about eight carbon atoms.

7. (canceled)

8. An oligomer as in any claim 2 wherein n is about 5 to about 10.

9. A process for producing an organophosphonate oligomer product which process comprises:
I) bringing together phosphoric trichloride and at least one diol, where the moles of phosphoric trichloride and the moles of diol are in a ratio of about x+y:x, where x represents the moles of phosphoric trichloride and is in the range of about 3 to about 6 and y represents the moles of diol and ranges from a value of a fractional number less than 1 to a value of about 2, to thereby form a first reaction mixture, forming a chlorophosphonate oligomer product;
II) bringing together at least a portion of said chlorophosphonate oligomer product from I) and at least one 1,2-epoxide, and optionally a catalyst, to thereby form a second reaction mixture, forming a chlorohydrocarbyloxy phosphonate oligomer product; and
III) bringing together at least a portion of said chlorohydrocarbyloxy phosphonate oligomer product composition from II) and
a) at least one trialkyl phosphite, to thereby form a third reaction mixture, and heating said third reaction mixture, or
b) at least one methyl alkyl alkanephosphonate and a catalyst, to thereby form a third reaction mixture,
forming an organophosphonate oligomer product.

10. A process as in claim 9 wherein said diol is a linear or branched diol which is an oxygen-containing diol, or wherein said diol is a diol having at least one cycloaliphatic or aromatic ring in the molecule, and wherein said diol has about eight to about twenty carbon atoms.

11. A process as in claim 9 wherein said diol is a linear or branched diol which is an alpha-omega alkane diol having about six to about twelve carbon atoms in the molecule.

12. A process as in claim 9 wherein said diol is diethylene glycol or dipropylene glycol.

13. (canceled)

14. A process as in claim 9 wherein said diol is a linear or branched diol or a diol having at least one cycloaliphatic ring in the molecule, and wherein said first reaction mixture is heated to a temperature in the range of about 20° C. to about 40° C., or wherein said diol is a diol having at least one aromatic ring in the molecule, and wherein said first reaction mixture is heated to a temperature in the range of about 70° C. to about 120° C.

15. (canceled)

16. A process as in claim 9 wherein y is in the range of about 0.75 to about 1.75.

17. A process as in claim 9 wherein said second reaction mixture is heated to a temperature in the range of about 70° C. to about 120° C.

18. A process as in claim 9 wherein in II) a catalyst is present, and wherein said catalyst is a titanium tetraalkoxide.

19. A process as in claim 9 wherein in II) the epoxide is represented by the formula 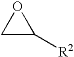
wherein R² is an alkyl group which has one to about eight carbon atoms, or
wherein R² is an aromatic group which has about six to about twelve carbon atoms.

20-21. (canceled)

22. A process as in claim 9 wherein said chlorohydrocarbyloxy phosphonate oligomer is brought together with a trialkyl phosphite, and wherein said third reaction mixture is heated to a temperature in the range of about 115° C. to about 180° C.

23. A process as in claim 9 wherein said chlorohydrocarbyloxy phosphonate oligomer is brought together with a methyl alkyl alkanephosphonate, and wherein said catalyst is an alkali metal carbonate.

24. (canceled)

25. A flame-retardant polymer composition formed from ingredients comprising a polymer and an organophosphonate oligomer of claim 2.

26. A flame-retardant polymer composition as in claim 25 wherein said polymer composition is a polyurethane composition.
